(19) United States
(12) Patent Application Publication
(10) Pub. No.: US 2005/0015177 A1
(43) Pub. Date: Jan. 20, 2005

(54) Embroidering and dyeing system

(75) Inventors: Seiichiro Hagino, Chiryu-shi (JP); Hisaharu Goto, Nagoya-shi (JP); Mikio Furuichi, Kuwana-shi (JP); Tsukasa Ando, Nishikasugai-gun (JP)

Correspondence Address: OBLON, SPIVAK, MCCLELLAND, MAIER & NEUSTADT, P.C., 1940 DUKE STREET, ALEXANDRIA, VA, 22314, US

(73) Assignee: AISIN SEIKI KABUSHIKI KAISHA, Kariya-shi (JP)

(21) Appl. No.: 10/892,091

(22) Filed: Jul. 16, 2004

(30) Foreign Application Priority Data
Jul. 16, 2003 (JP) 2003-198004
Jul. 16, 2003 (JP) 2003-198005

(51) Int. Cl. G06F 19/00; D05B 21/00

(52) U.S. Cl. 700/132

(57) ABSTRACT

An embroidering and dyeing system includes a controller, an embroidering machine controlled by the controller, and a dyeing device controlled by the controller. The dyeing device is operable independently from the embroidering machine. An objective pattern formed by the embroidering machine and/or the dyeing device and progress for forming the objective pattern are displayed on a screen.

### CROSS REFERENCE TO RELATED APPLICATIONS

This application is based on and claims priority under 35 U.S.C. §119 with respect to Japanese Patent Application No. 2003-198004 filed on Jul. 16, 2003 and Japanese Patent Application No. 2003-198005 filed on Jul. 16, 2003, the entire contents of which are incorporated herein by reference.

### FIELD OF THE INVENTION

The present invention relates to an embroidering and dyeing system. More particularly, the present invention pertains to an embroidering and dyeing system for embroidering on a work piece either before or after dyeing.

### BACKGROUND

Embroidering and dyeing systems for embroidering on a work piece (e.g., garment) has been desired in the apparel industry or business. Japanese Patent Laid-Open Publication No. H05-272046 provides an embroidering machine integrated with a dyeing device, by which the above desire has become satisfied.

Indeed the embroidering and dyeing system described in Japanese Patent Laid-Open Publication No. H05-272046 deserves to be praised for meeting the above desire.

However, with the construction of the known embroidering and dyeing system described in Japanese Patent Laid-Open Publication No. H05-272046, there are some drawbacks in practice. That is, while the above embroidering and dyeing system continues to dye plural patterns on a work piece or cloth consecutively, the operator always has to watch the progress of the pattern formed on the cloth, which prevents the operator from leaving his/her position.

Further, in the above embroidering and dyeing system, the embroidering data and the dyeing data for producing the embroidery patterns and the dyeing patterns, respectively, are given or fixed, which makes it impossible to modify or change the embroidery patterns and the dyeing patterns.

A need thus exists to provide an embroidering and dying system which is free from the above-mentioned drawbacks.

### SUMMARY OF THE INVENTION

In light of the foregoing, a first aspect of the present invention is to provide an embroidering and dyeing system which comprises: a controller; an embroidering machine controlled by the controller; and a dyeing device controlled by the controller, the dyeing device being operable independently from the embroidering machine; wherein an objective pattern formed by the embroidering machine and/or the dyeing device and processes for forming the objective pattern are displayed on a screen.

A second aspect of the present invention is to provide an embroidering and dyeing system whose subject matter is to modify the embroidering and dyeing system of the first aspect such that the objective pattern and the processes for forming the objective pattern are displayed on the screen individually or collectively.

A third aspect of the present invention is to provide an embroidering and dyeing system whose subject matter is to modify the embroidering and dyeing system of the first aspect such that the objective pattern is capable of being changed in color and/or configuration.

A fourth aspect of the present invention is to provide an embroidering and dyeing system whose subject matter is to modify the embroidering and dyeing system of the third aspect such that the change of the objective pattern is made via the screen.

A fifth aspect of the present invention is to provide an embroidering and dyeing system whose subject matter is to modify the embroidering and dyeing system of the first aspect such that the objective pattern is displayed together with its component configurations.

A sixth aspect of the present invention is to provide an embroidering and dyeing system whose subject matter is to modify the embroidering and dyeing system of the fifth aspect such that the objective pattern and the component configurations appear on upper and lower sides, respectively, in the screen.

A seventh aspect of the present invention is to provide an embroidering and dyeing system whose subject matter is to modify the embroidering and dyeing system of the sixth aspect such that the component configurations displayed on the screen are arranged in process sequence.

An eighth aspect of the present invention is to provide an embroidering and dyeing system whose subject matter is to modify the embroidering and dyeing system of the seventh aspect such that each of the component configurations, during formation thereof, is lit for clarification.

A ninth aspect of the present invention is to provide an embroidering and dyeing system according whose subject matter is to modify the embroidering and dyeing system of the seventh aspect such that an on-screen indication appears near each of the component configurations in order to indicate whether the formation thereof is to be embroidering or by dyeing.

A tenth aspect of the present invention is to provide an embroidering and dyeing system whose subject matter is to modify the embroidering and dyeing system of the ninth aspect such that the on-screen indication and the corresponding component configuration are arranged in column.

An eleventh aspect of the present invention is to provide an embroidering and dyeing system whose subject matter is to modify the embroidering and dyeing system of the tenth aspect such that the on-screen indication is placed just above the corresponding component configuration.

A twelfth aspect of the present invention is to provide an embroidering and dyeing system whose subject matter is to modify the embroidering and dyeing system of the ninth aspect such that during formation of each of the component configurations, at least one of the each of the component configurations and the corresponding on-screen indication is lit for clarification.

A thirteen aspect of the present invention is to provide an embroidering and dyeing system whose subject matter is to modify the embroidering and dyeing system of the first aspect such that the embroidery machine and the dyeing device embroideries and dyes, respectively, a work piece which is held on a common frame device.

A fourteenth aspect of the present invention is to provide an embroidering and dyeing system whose subject matter is to modify the embroidering and dyeing system of the thirteenth aspect such that the embroidery machine and the dyeing device terminate respective operations, a command appears as to a next procedure.

A fifteenth aspect of the present invention is to provide an embroidering and dyeing system whose subject matter is to modify the embroidering and dyeing system of the thirteenth aspect such that the embroidery machine and the dyeing device terminate respective operations a buzzer sounds.

A sixteenth aspect of the present invention is to provide an embroidering and dyeing system whose subject matter is to modify the embroidering and dyeing system of the thirteenth aspect such that the embroidering and dyeing system of the thirteenth 13 aspect such that whenever the embroidery machine and the dyeing device terminate respective operations a command appears as to a next procedure and a buzzer sounds.

### BRIEF DESCRIPTION OF THE DRAWINGS

The foregoing and additional features and characteristics of the present invention will become more apparent from the following detailed description considered with reference to the accompanying drawings, wherein:

FIG. 1 shows an overview of an embroidering and dyeing system according to the present invention.

FIG. 2 shows a perspective view of an embroidering machine of the embroidering and dyeing system shown in FIG. 1.

FIG. 3 shows a block view illustrating a control system of the embroidering machine of the embroidering and dyeing system shown in FIG. 1.

FIG. 4 is a flowchart showing how to calculate an embroidering time when pattern data is inputted into the embroidering machine shown in FIG. 2.

FIG. 5 is a flowchart showing how to calculate an embroidering time while an embroidering operation is being done in the embroidering machine shown in FIG. 2.

FIG. 6 shows a perspective view of a dyeing machine of the embroidering and dyeing system shown in FIG. 1.

FIG. 7 shows a block view illustrating a control system of the dyeing device shown in FIG. 6.

FIG. 8 shows a cross-sectional view of the dyeing device in X-direction shown in FIG. 6.

FIG. 9 shows a cross-sectional view when a thick cloth is held in the dyeing device shown in FIG. 6.

FIG. 10 shows a cross-sectional view of a printer after adjusting the height of a table in accordance with the thickness of the cloth shown in FIG. 9.

FIG. 11 shows a cross-sectional view of an ink injection portion of the dyeing device shown in FIG. 6.

FIG. 12 shows a cross-sectional view of the dyeing device shown in FIG. 6 when another cloth is positioned.

FIG. 13 shows an example of an ultimate objective pattern.

FIG. 14 is a view showing contents displayed on a screen during forming of the pattern of FIG. 13.

### DETAILED DESCRIPTION OF THE PRESENT INVENTION

[Overview of Embroidering and Dyeing System EBS]

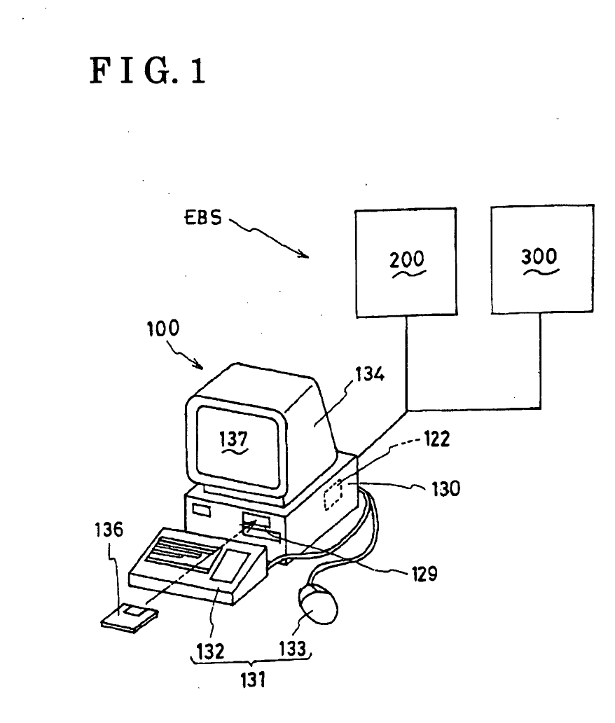

As shown in FIG. 1, an embroidering and dyeing system EBS includes a control device 100, an embroidering machine 200, a dyeing device 300. Though each of the embroidering machine 200 and the dyeing device 300 is made separate from the control device 100, each of the embroidering machine 200 and the dyeing device 300 is under a control of the control device 100.

In the above embodiment of the present invention, a commercially available personal computer is used as the control device 100. Of course, instead of the personal computer, a specially designed microcomputer is available.

As shown in FIG. 1, a CPU 122 serving as a principal element of the control device 100 is accommodated in a casing 130 on which is mounted a display 134 serving as a displaying device. An inputting means 131 including a keyboard 132 and a mouse 133 is connected to the CPU 122. A disc drive 129 for reading in various data from a flexible disc is provided. The disc drive 129 is connected to the CPU 122. The data read in the CPU 122 is memorized in an internal memory.

When a starting switch (not shown) is turned on, the control device 100 assumes an operational state. Simultaneously, an initial picture appears on a screen 137 of the display 134 so that plural embroidering patterns are displayed in order. The patterns are, for example, mainly categorized as follows.

(A) Pattern attained by dyeing with the dyeing device 300 after embroidering on a work piece or cloth W with the embroidering machine 200.

(B) Pattern attained by embroidering on a work piece or cloth W with the embroidering machine 200 after dyeing the cloth W with the dyeing device 300.

(C) Pattern attained by embroidering on a work piece or cloth W with the embroidering machine 200.

(D) Pattern attained by dyeing a work piece or cloth W with the dyeing device 300.

When clicking a desired pattern selected from the above ones with the mouse 133, a second picture appears which will be explained later. The contents of the second picture vary depends on which is selected from (A)-(D).

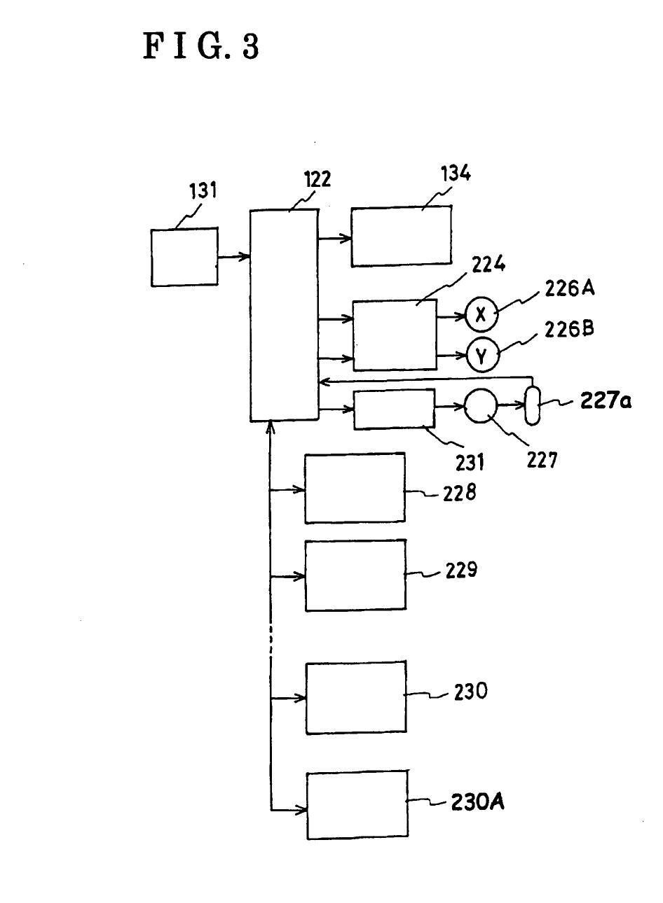

Thus, when one of the patterns is selected, the corresponding pattern data is read from one of the memories, 228, 229, 230, and 230A (shown in FIG. 3) so that the embroidering machine 200 and/or the dyeing device 300 operate to create the selected pattern on the work piece or cloth W.

The embroidering and dyeing system EBS is constructed such that the dyeing device 300 is added to the conventional embroidering and dyeing system comprising the control device 100 and the embroidering device 200 and the embroidering device 200 and the dyeing device 300 are made to operate by newly loaded programs into the control device 100.

Hereinafter, a construction of the embroidering machine 200, an operation of the embroidering machine 200, a construction of the dyeing device 300, and an operation of the dyeing device 300 will be detailed in such an order and thereafter an overall operation of the embroidering and dyeing system EBS will be detailed.

[Construction of Embroidering Machine 200]

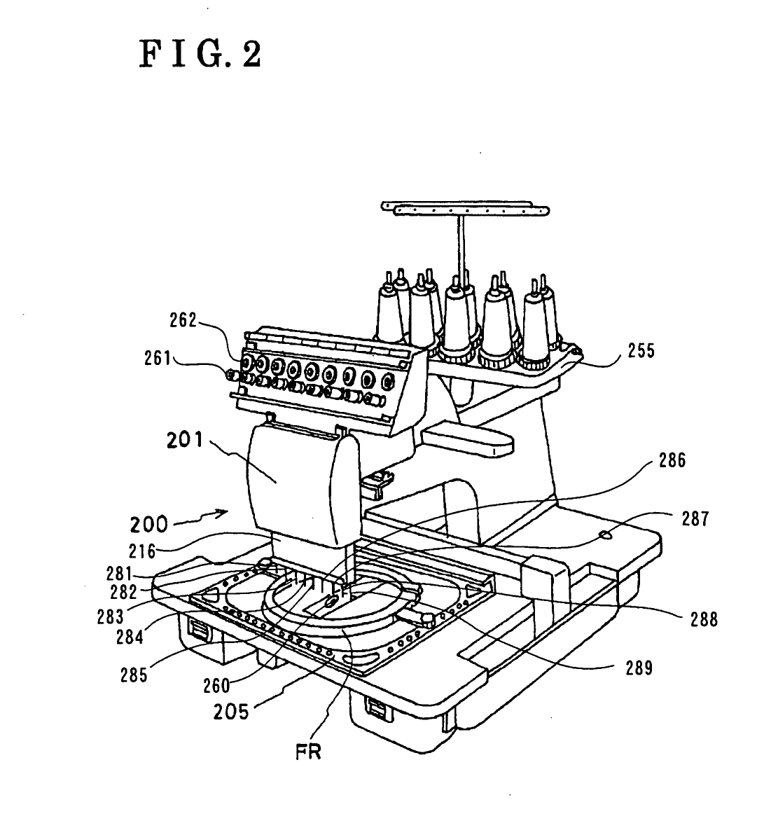

The construction of the embroidering machine 200 will be explained with reference to FIGS. 2-3. The embroidering machine 200 includes a sewing machine 201 and an X-Y table 205 positioned under the sewing machine 201. The X-Y table 205 includes an embroidery frame drive portion operated by an X-motor 226A and Y-motor 226B (shown in FIG. 3). An embroidery frame device FR is attached to the embroidery frame drive portion. The moving amount and the moving direction of the embroidery frame device FR moved by the embroidery frame drive portion is calculated by the embroidery data.

Each of needles 281-289 of the sewing machine 201 is set to be moved in the vertical direction by an upper shaft motor 227. Thus, after holding the cloth W to the embroidery frame device FR, the embroidering machine 200 embroiders the pattern on the cloth W according to the pattern data of the selected pattern.

In detail, the embroidering machine 200 includes an embroidering frame actuation portion for actuating the embroidering frame device FR in horizontal 2D mode (i.e. X-direction and Y-direction) by the X-motor 226A and the Y-motor 226B, the sewing mechanism 201 for actuating embroidering needles 281-289 positioned just above a needle piercing hole 260, and a needle selecting device 216 such as one described in Japanese published examined applications Nos. S53-43336 and S55-8626. The needle selecting device 216 selectively set one of needles 581-589 at just above the needle piercing hole 260, thus the embroidering is performed using the thread guided at the needle positioned just above of the needle piercing hole 260.

The sewing machine arm is attached with a bobbin holder 255. The bobbin holder 255 can accommodate ten bobbins. Thread wound on each of nine bobbins is guided to the corresponding each of the needles 581-589 via a tension 261 and a thread guiding board 262 and a hole provided at a thread take-up lever.

The pattern data is specified with a proper name (i.e., file name). The information for the embroidering of the particular name of each pattern includes a small number of management data and a large number of stitch data. The management data includes the data for a predetermined thread color Ci and selecting order of the thread color. The stitch data is divided into control data and frame actuation amount data. The control data includes thread substitution command data and end command data (i.e., embroidering completion command data). The frame actuation amount data is indicative of a predetermined actuation amount (X-axis moving amount and Y-axis moving amount) from the last embroidering frame position (i.e., the frame center is positioned at the right above of the needle piercing hole 260 at the start). With the stitch data, the frame actuation amount data is arranged in order by one stitching unit when the thread substitution is not performed and the embroidering is not completed. The thread substitution command data is provided at the timing of the thread substitution. The timing for ending the embroidering, that is the end of the stitch data, is the end command data. The thread color adopts the RGB code.

Before the embroidery and dyeing system EBS is brought into operation, the memory device of the control device 100 (i.e. personal computer) memorizes the thread color supplied to the needles 281-289 and the needle number N1-N9 designated to the nine needles 281-289 of the embroiling machine 200 in the form of pairs [NJ, CJ] (j=1-9) via the input device such as keyboard or the mouse.

While the embroidering and dyeing system EBS is in operation, the following steps are performed for embroidering a multi color pattern with the embroidering machine 200.

(1) An image of the multi color pattern to be embroidered is displayed on the display 134. In the pattern displayed on the screen 137, each of the threads is in the form of a line colored with the corresponding color.

(2) As to one of the thread, when the currently displayed color is desired to change to a different color, the operator selects the favorable color from a color data table shown on the screen when clicking the line. Thereafter, the content of the predetermined thread color Ci of the management data is corrected and the needle number Ni is added corresponding to the selected color. In case the selected colored thread is provided at none of the needles, the line representative of the thread is regarded as being dyed. Instead, in such a case, a tread is selected from the provided colored threads which has a most similar or closest color to the initially designated color.

(3) The embroidering data is sent from the control device 100 to the CPU of the embroidering machine 200.

(4) The embroidering machine 200, when receives the embroidering data, is actuated to produce the multi color embroider pattern defined by the embroidering data.

The CPU 122 in the control device 100 serves as an embroidering time calculation means for converting the embroidering data into the time, a required time calculation means, and a remaining time calculation means. In other words, the CPU 122 is connected to program memories written with the aforementioned calculation programs, a RAM as a temporary memory in operation, memories 228, 229, 230, and 230A written with the plural pattern data, a drive means 231 for driving the upper shaft motor 227, and a pulse distribution circuit 224 for driving the X-motor 226A and the Y-motor 226B.

When one of the keyboards 132 and the mouse 133 is manipulated both of which constitutes the input means 131, one of the memories 228, 229, 230, and 230A assumes readable to read the selected pattern data. The pattern data indicates the needle piercing point in plane coordinate to the embroider frame device FR. The ratio between needle piercing points of the consecutive two pattern data of the length in the X direction and the length in the Y direction commands the pulse distribution ration of the X-motor 226A and the Y-motor 226B. The length of the hypotenuse of the right triangle determined by the length in the X-direction and the length in the Y-direction determines the pitch length between the consecutive needle piercing points, and the upper shaft motor 227 varies the rotational speed in accordance with the pitch length. The upper shaft motor 227 is attached with an encoder 227a. The pulse output of the encoder 227a assumes a reference drive signal for driving the X-motor 226A and the Y-motor Y by feedback to the CPU 122.

At this stage, the operator can select the highest rotational speed of the upper shaft 227. The highest rotational speed corresponding to the embroidering speed determines the embroidering precision. The highest rotational speed of the top shaft motor 227 adjusts the rotational speed of the upper shaft 227 determined in accordance with the pitch length.

[Operation of Embroidering Machine 200]

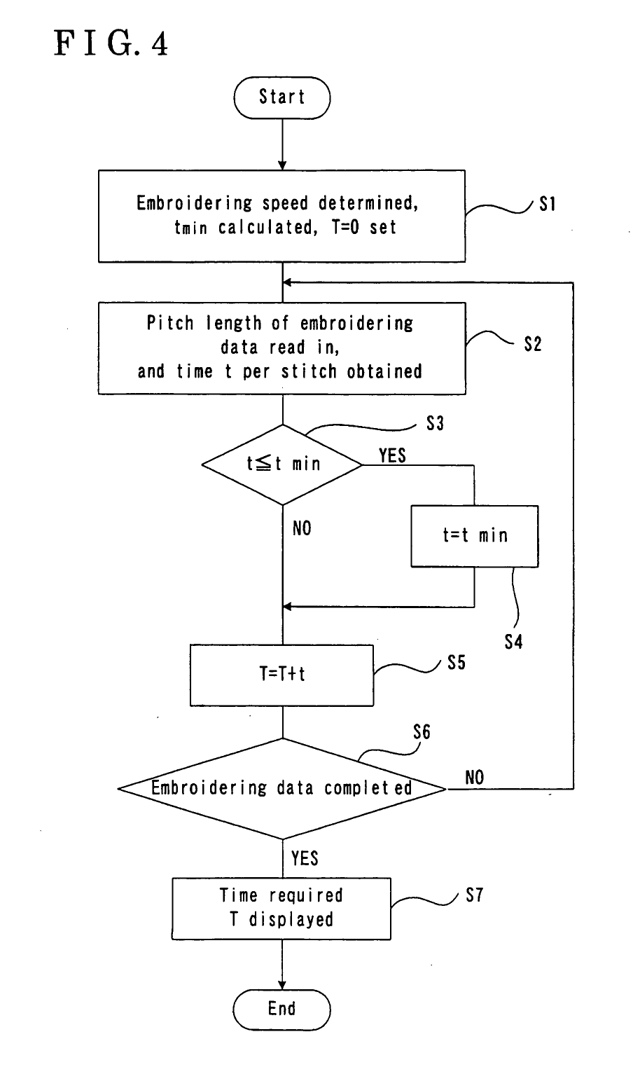

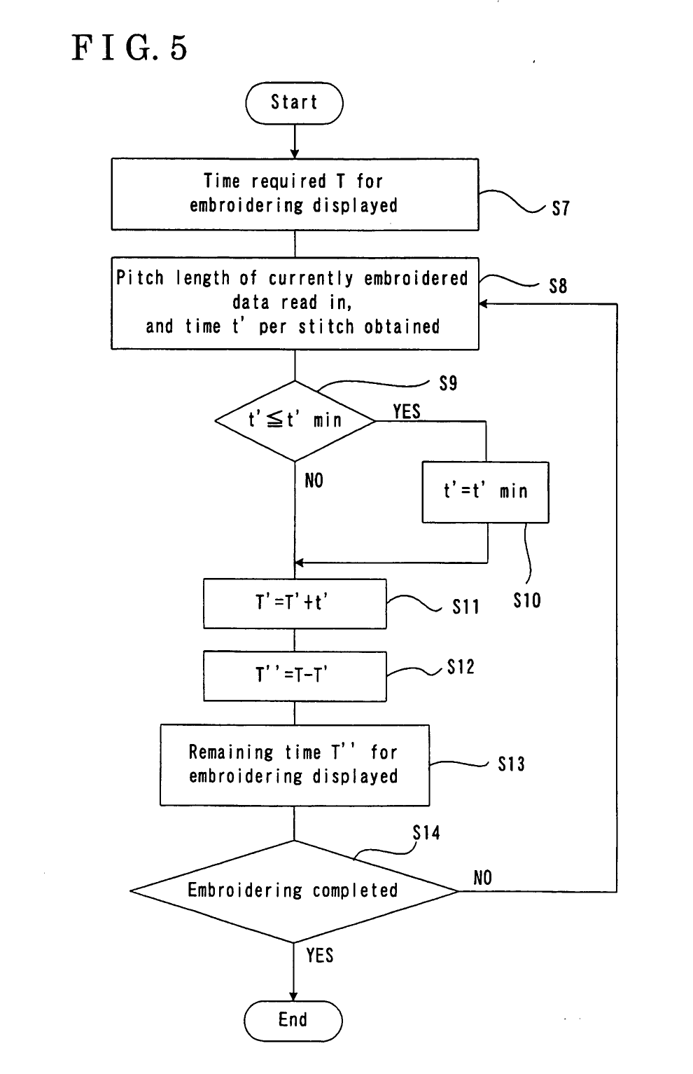

Hereinafter, the operation of the embroidering machine 200 will be explained with reference to FIGS. 4-5 as follows. As shown in FIG. 4, the flowchart shows the calculation of the required time from the start to the end of the embroidering at the input of the pattern data. Before entering the main routine, the operator sets the cloth W at the embroidering device FR. After the cloth is placed as mentioned above, at Step S1, the CPU 122 calculates the embroidering time tₘᵢₙ corresponding to the pitch length at the selected embroidering speed. In this case, the value of a total register of the embroidering time is set to zero (=0).

At Step S2, each pitch length is calculated from every two consecutive embroidering data to obtain the embroidering time per stitch. The embroidering time per stitch is obtained based on the rotational speed of the upper shaft motor 227 which is determined by the pitch length. When the embroidering time t per stitch obtained at Step S2 is greater than the embroidering time tₘᵢₙ determined by the embroidering speed at the judgment of Step S3, t is added, as it is, to the total register. When the embroidering time t per stitch obtained at Step S2 is equal to or less than the embroidering time tₘᵢₙ, t is determined to be tₘᵢₙ (t=tₘᵢₙ) at Step S4 and the control goes to Step S5. At Step S5, the embroidering time t of every two consecutive embroidering data is summed. At Step S6, whether the embroidering data is left is judged.

The routine of Steps S2-S6 is repeated until the operation is completed for the all pattern data. When the judgment of Step S6 shows that the data is not left (YES), the required time T from the start to the end of the embroidering is obtained. The required time T is shown on the screen 137 of the display 134. After displaying the required time T, the embroidering operation starts. With the embroidering machine 200, the remained time of the embroidering time shown in FIG. 5 is displayed by the interrupting routine even during the embroidering operation. The calculation procedure shown in FIG. 5 is similar to that in FIG. 4 except that the embroidering time per open stitch is obtained from the two consecutive embroidering data read out during the embroidering operation to be successively subtracted from the required time T.

In detail, when the embroidering operation starts at a state that the required time T is displayed at Step S7, the embroidering data is successively read out. The CPU 122 calculates the pitch length of needle piercing points by the two consecutive embroidering data on the process of embroidering to obtain an embroidering time t′ of every consecutive embroidering data by the calculation likewise at Step S2. The embroidering time t′ is compared to the embroidering time t′ₘᵢₙ at Step S9. In case the embroidering time t′ is greater than the embroidering time t′ₘᵢₙ, the transaction is forwarded to Step 11. In case the embroidering time t′ is equal to or less than the embroidering time t′ₘᵢₙ, the embroidering time t′ and the embroidering time t′ₘᵢₙ is equalized at Step S10 and the transaction is forwarded to Step S11. Step S11 corresponds to Step 5 for calculating the total embroidering time T′ used for the embroidering operation thus far. At Step S12, the total embroidering time T′ is subtracted from the required time T. The remaining embroidering time T″ is displayed at Step S13. After displaying at Step S13, the control returns to Step S8 when the further pattern data is left at Step S14. A loop from Step S8 to Step S14 is repeated until the operation for the all data is completed at Step S14.

With the construction of the present invention, because the embroidering time per stitch is obtained from the pattern data to calculate the total required time to be displayed before the embroidering operation, the required time from the start to the end of the embroidering is judged. Thus, the precise time management for arranging the embroidering and the other operation can be achieved, which increases the production performance and assumes easier to estimate the productivity per time.

In addition, because the embroidering time t′ of the every consecutive embroidering data during the embroidering process is obtained and summed to be subtracted from the required time T, the remaining time T″ until the end of the embroidering can be displayed. Further, because the embroidering time t′ for the every consecutive embroidering data during the embroidering process is obtained to be summed, the passage of time in accordance with the progress of the embroidering operation can be displayed while displaying the required time at the screen 137.

[Construction of Dyeing Device 300]

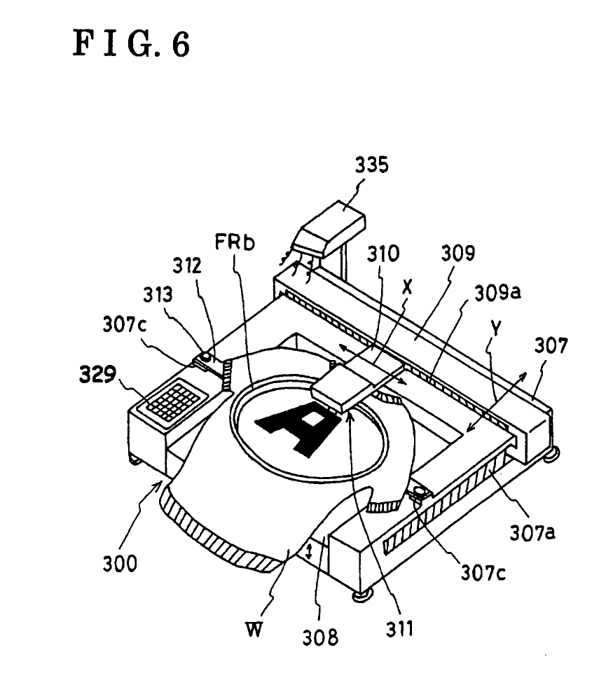

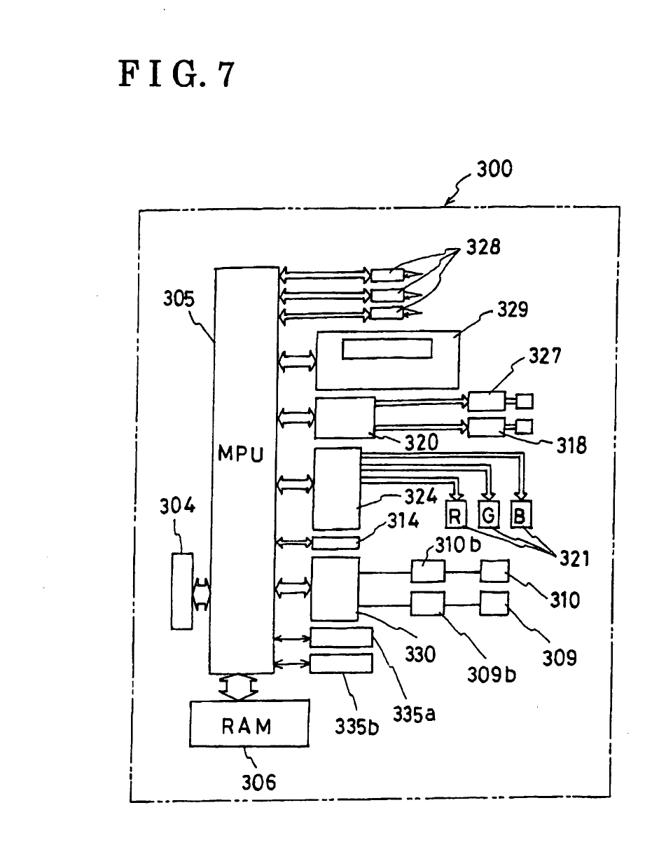

Hereinafter, the construction of the dyeing device 300 will be explained referring to FIGS. 6-7. As shown in FIGS. 6-7, the dyeing device 300 includes an independent or its own MPU (central processing unit) 305. The dyeing information is read into a RAM 306 from the CPU 122 of the control device 100 via an interface 304 and the MPU 305, either successively or collectively.

As best shown in FIG. 6, a frame 307 of the dyeing device 300, which is of an inverted U shape, is provided at its central portion with a table 308 such that the table 308 is movable in the vertical direction. An operational panel 329 is provided at a top surface of the frame 307 for doing input operations to the MPU 305 independently from the dyeing information sent from the CPU 122. A warm air current generator 335 including a heater 335a and a fan 335b for providing the warm current of the air to the top surface of the cloth W is provided at an end portion of the frame 307. Grooves 307a are provided at sides of the frame 307. End portions of Y-direction movement bar 309 moving in the Y-direction along the groove 307a is provided at the groove 307a. A groove 309a is provided at side surface of the Y-direction bar 309. An X-direction movement arm 310 provided with a printing portion 311 at a tip end thereof is provided at the groove 309a to be movable in the X-direction. When the actuation is commanded from the MPU 305 to an XY-motor drive 330 (shown in FIG. 7), the X-motor 310b and the Y-motor 309b rotate in accordance with the moving distance so that the X-direction movement arm 310 and the Y-direction bar 309 moves to move the printing portion 311 two-dimensionally.

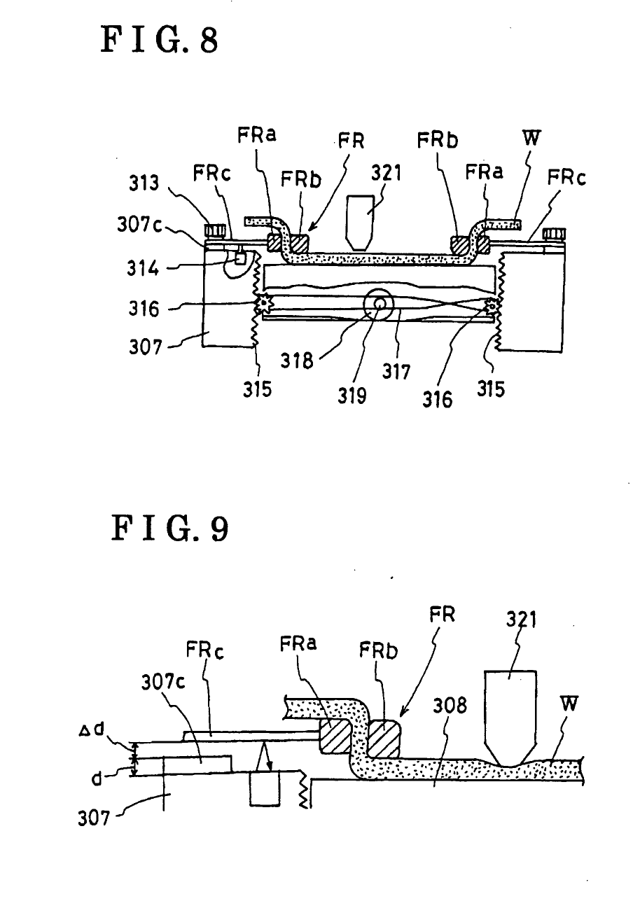

A holding frame device FR (shown in FIGS. 8-10) for holding the cloth W includes a circular frame body FRa (shown in FIG. 8-10), an engagement frame device FRb engaging at an internal periphery of the frame body FRa for holding the cloth W between the frame body FRa, and an attaching portion FRc secured to the end portions of the frame body FRa to be extended towards the frame 307. A pair of stepped portion 307c is formed at the top surface of the frame 307. The holding frame device FR is fixed to the stepped portion 307c via screws. As shown in FIG. 8, a sensor 314 is provided at a portion immediately bottom of one of the attaching portions FRc. The sensor 314 is connected to the MPU 305 and detects the distance between the frame 307 and the attaching potion FRc for transmitting to the MPU 305.

A pinion 315 is formed at an inner surface of the frame 307. A pair of rack 316 geared with the pinion 315 is pivoted at the side surfaces of the table 308. A belt 317 is wound around the racks 316. A stepping motor 318 with a rotational shaft 319 is positioned in the table 308. The belt 317 is geared with the rotational shaft 319. When the actuation is commanded to the stepping motor 318 from the MPU 305 via the motor drive 320, the belt 317 and the rack 316 rotate. In this case, because the belt 317 is twisted and wound around the rack, the racks 316 rotates in the opposite direction by the rotation of the stepping motor 318. Thus, the table 308 moves upward when the stepping motor 318 rotates in the clockwise direction of FIG. 9. The table 308 moves downward when the stepping motor 318 is driven in the counterclockwise direction.

The construction of the printing portion 311 provided at a distal end of the X-direction movement arm 310 will be explained as follows. As shown in FIG. 11, the printing portion 311 includes three ink heads for storing therein red, green, and blue inks respectively. The ink head 321 is fixed to an ink head holding member 322. When the command for dyeing is transmitted from the MPU 305 to a head drive 324 (shown in FIG. 7), the ink head 321 having the specified color moves downward from the ink head holding member 322 to dye on the cloth W. A sensor 328 is provided on the ink head holding member 322 corresponding to each ink head 321. The sensor 328 detects the distance from the cloth W to send to the MPU 305. The both ends of the ink head holding member 322 are positioned through a pair of guide bar 323 provided in the X-direction movement arm 310. Pulleys 325a, 325b adjacent to the guide bar 323 are arranged at the top and bottom at the internal surface of the X-direction movement arm 310. An ink head motor 327 mounts thereon the pulley 325a. A belt 326 is tensioned between the pulleys 325a and 325b. An end portion of the ink head holding member 322 is attached at the belt 326. Thus, by the rotation of the pulleys 325a, 325b by the operation of the ink head motor 327, the belt 326 rotates to actuate the ink head holding member 322 upward and downward along the guide bar 323. It is to be noted that instead four ink heads are available which store therein blue, black, red, and yellow inks, respectively.

The reason for providing the independent MPU 305 in the dyeing device 300 is to make it possible to operate the dyeing device 300 independently or freely from the control device 100. In other words, another cloth can be dyed resulting from connecting a scanner (not shown) to the interface 304 and subsequent memorizing the figure read from the scanner in a RAM 306 as digital information.

[Operation of Dyeing Device 300]

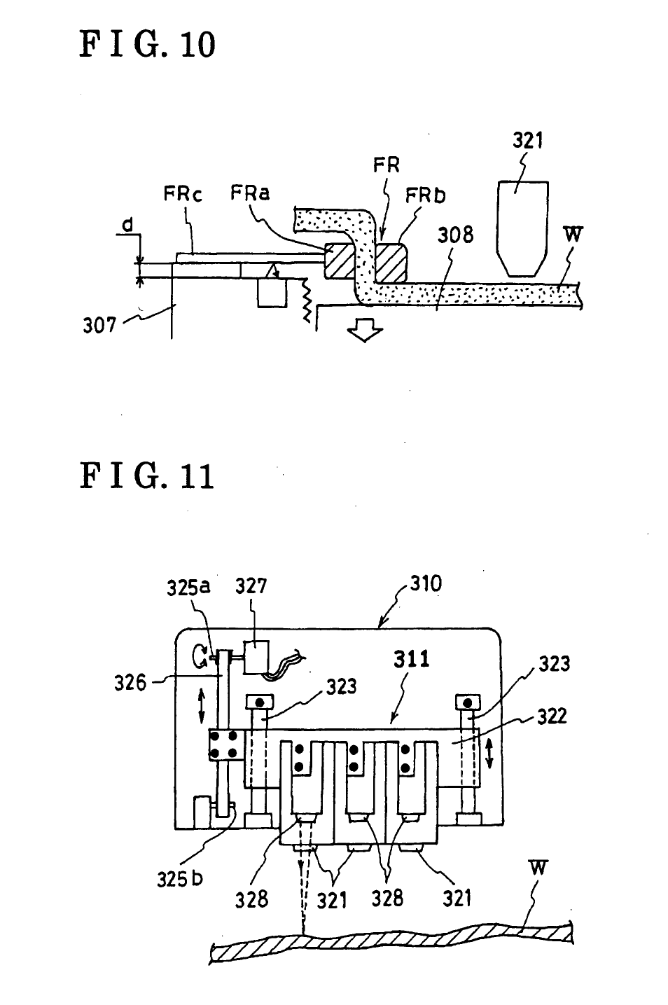

Hereinafter, the operation of the dyeing device 300 will be explained referring to FIGS. 10-12 as follows. First, the cloth W is set at the holding frame device FR under a condition that a screw 313 is loosened which serves for fixing the holding frame device FR to the frame 307. At this time, the table 308 is positioned at its fully raised or highest level. Setting the cloth W at the holding frame device FR causes the attaching portion FRc of the holding frame device FR to raise or move upward by a distance corresponding to the thickness Δd of the cloth W (shown in FIG. 10). An indication from the operational panel to adjust or correct the height of the table 308 causes the sensor 314 to measure the distance between the frame 307 and the attaching portion 312c, thereby sending the resultant distance to the MPU 305. Immediately upon receipt of the distance, the MPU 305 sends the command to the motor drive 320 for driving the stepping motor 318 to move the table 308 downward by a distance of Δd. Thus, the distance between the frame 307 and the attaching portion FRc is adjusted to be d and the distance between the ink head 321 and the cloth W is adjusted simultaneously (shown in FIG. 11). When the command to start the dyeing is sent, the MPU 305 send the command to scan the X-direction movement arm 310 and the Y-direction movement bar 309 per one line or per plural lines based on the dyeing information inputted in the RAM 306 and dyes the cloth W by moving the ink heads 321 from which respective three inks R-G-B: red, green, and blue are injected.

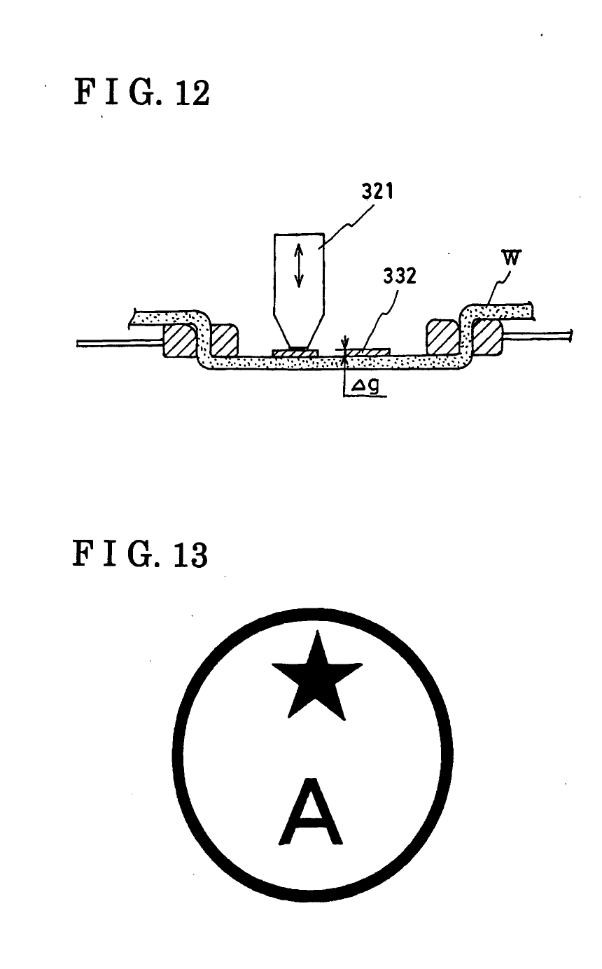

As foregoing, although the cloth W is dyed while maintaining a predetermined distance between the cloth W and each of the ink heads 321, when a different cloth 332 such as an appliqué is partially overlapped on the cloth W as shown in FIG. 12, the height between each of the ink heads 321 and the different cloth 332 is adjusted in the following manner. The sensor 328 provided adjacent to the ink head 321 always detects the distance between the tip end of each of the ink heads 321 and the cloth W and between the tip end of each of the ink heads 321 and the different cloth 322 and the sensor 328 feeds the resultant each distance to the MPU 305. When the distance exceeds a predetermined length, the MPU 305 commands the motor drive 320 for actuating the ink head motor 327 to move the ink head holding member 322 upward. When no stepped portion is recognized on the cloth W, the ink head holding portion 322 is moved downward.

When the warm current of the air is commanded to be sent from the operation panel 329 while dyeing, the MPU 305 commands the heater 335a and the fan 335b to energize for sending warm current of the air toward the cloth W from the warm air current generator 335, thereby drying the inks on the cloth W immediately.

[Overall Operation of Embroidering and Dyeing System: EBS]

Hereinafter, the overall operation of the embroidering and dyeing system EBS will be explained as follows. When the starting switch is turned on, the control device 100 becomes ready for operation or stand-by state. Simultaneously, the initial picture appears at the screen 137 of the display 134 so that the plural arranged patterns are displayed. The patterns mainly include, for example, the following categories.
(A) Pattern attained by dyeing with dying device 300 after embroidering on the work piece or cloth W with the embroidering machine 200.
(B) Pattern attained by embroidering on the work piece or cloth W with the embroidering machine 200 after dyeing the cloth W with the dyeing device 300.
(C) Pattern attained by embroidering on the work piece or cloth W with the embroidering machine 200.
(D) Pattern attained by dyeing the work piece or cloth W with the dyeing device 300.

When clicking one of the desired patterns with the mouse 133, the second picture including the selected pattern and the command in accordance with the selected pattern appears on the screen in accordance with the selected pattern. The operation of the embroidering and dyeing system will be explained depending on the selected patterns.

Upon selection of (A) i.e. upon selection of the pattern attained by dyeing with dying device 300 after embroidering on the work piece or cloth W with the embroidering machine 200 the screen 137 displays the color image of the pattern. In the on-screen pattern, each thread is in the form of a colored line illustration. To change the color with respect to a specific thread, a favorite color can be selected from color table which appears on the screen 137 immediately clicking the initially displayed line. Then, the content of the predetermined thread color Ci of the management data is corrected and the needle number Ni is added corresponding to the selected color. When no thread of the newly selected color is fed to any one of the needles, the line to be embroidered by the thread of the newly selected color is automatically read as the line to be printed or dyed, thereby modifying or the dyeing data.

Thereafter, a command message appears on the screen which says “Input the frame number, and mount a cloth set frame on the embroidering machine” or the like. When the embroidering machine 200 is initiated after inputting the frame number indicative of the size of the frame device FR set with the cloth W via the screen 137 and subsequent mounting of the frame device FR set with the cloth W to the embroidering machine 200, the frame device FR is moved to the embroidering start point according to the size thereof to apply the predetermined embroider on the cloth W. During the embroidering operation, a time duration until completing the operation is displayed at the screen 137. When the embroidering operation is completed, the buzzer sounds and a command appears on the screen which says “set the cloth at the dyeing device without removing from the frame”, or the like. After mounting the frame device FR set with the cloth W on the dyeing device 300 according to this message, when the dyeing device 300 is initiated, the frame device moves to the dyeing starting point according to the size thereof (i.e., the size is previously known to the control device 100 when inputted at the screen 137), one or more specific portions of the embroidered cloth W are dyed. When the ink is completely dried after completion of the dyeing operation, the buzzer sounds and a command appears on the screen which says “remove the frame”, or the like. Accordingly, the cloth W which is dyed after embroider can be obtained. It is to be noted that during the embroidering operation changing the dyeing device 300 in another operation mode makes it possible to dye another cloth therewith.

In case of (B) i.e. if the pattern attained by embroidering on the work piece or cloth W with the embroidering machine 200 after dyeing the cloth W with the dyeing device 300 is selected embroidering by the embroidering machine 200 after dyeing the cloth W by the dyeing device 300 is selected, the image of the pattern is displayed on the screen 137. In the on-screen pattern, each thread is in the form of a colored line illustration. To change the color with respect to a specific thread, a favorite color can be selected from color table which appears on the screen 137 immediately clicking the initially displayed line. Then, the content of the predetermined thread color Ci of the management data is corrected and the needle number Ni is added corresponding to the selected color. When no thread of the newly selected color is fed to any one of the needles, the line to be embroidered by the thread of the newly selected color is automatically read as the line to be printed or dyed, thereby modifying or the dyeing data.

Thereafter, a command appears on the screen which says “input the frame number, and set the frame set with the cloth to the dyeing device” or the like. After inputting the number indicating the size of the frame device FR set with the cloth W via the screen 137 and subsequent mounting of the frame device FR with the cloth W pursuant to this command, when the dyeing device 300 is initiated to operate, the frame device FR is moved to an initial position for the dyeing in accordance with the size of the frame device FR so that the predetermined dye is made on the cloth W. When the dyeing operation is completed and the ink is completely dried, the buzzer sounds and a command appears on the screen 137 which says “set the frame to the embroidering device without removing the cloth from the frame” or the like. Pursuant to this command, after mounting the frame device FR with the dyed cloth W held thereon in tension on the embroidering machine 200, when the embroidering machine 200 is initiated to operate, the frame device FR is moved to an initial position for the embroidering in accordance with the size of the frame device FR (i.e., the size of the frame device FR is previously known to the control device 100 when inputted via the screen 137) so that a predetermined embroider is made on the cloth W. During the embroidering operation, the time until the completion of the operation is displayed on the screen 137. When the embroidering operation is completed, the buzzer sounds and the command saying “remove the frame” or the like is displayed. Thus, the embroidered cloth W after dyeing can be obtained. It is to be noted that during the embroidering operation changing the dyeing device 300 in another operation mode makes it possible to dye another cloth therewith.

In case of (C) i.e. upon selection of the pattern attained by embroidering on the work piece or cloth W with the embroidering machine 200, a command appears on the screen 137 which says “input the frame number, and set the frame set with the cloth W to the embroidering machine” or the like. Pursuant to this command, after inputting the number showing the size of the frame device FR set with the cloth W via the screen 137 and mounting thereof on the embroidering machine 200, initiating the embroidering machine 200 causes the frame device FR to move to an initial position for the embroidering in accordance with the size of the frame device FR so that a predetermined embroider is made on the cloth W. During the embroidering operation, the time until the completion of the operation is displayed on the screen 137. When the embroidering operation completes, the buzzer sounds and a command appears on the screen 137 which says “remove the frame” or the like. Thus, the cloth W provided with the embroidery can be obtained. It is to be noted that during the embroidering operation changing the dyeing device 300 in another operation mode makes it possible to dye another cloth therewith.

In case of (D) i.e. upon selection of the pattern attained by dyeing the work piece or cloth W with the dyeing device 300, a command appears on the screen 137 which says “input the frame number, and set the frame set with the cloth to the dyeing device”. After inputting the number for indicating the size of the frame device FR set with the cloth W via the screen 137 and subsequent mounting thereof on the dyeing device 300 pursuant to this command, initiating the dyeing device 300 causes to made a the predetermined dye on the cloth W. When the dyeing operation is completed and the ink is completely dried, the buzzer sounds and the command saying “remove the frame” can be displayed. Thus, the cloth W provided with the dyeing can be obtained. The same pattern can be obtained even if the dyeing device 300 is operated independently from the embroidering machine 200.

[On-Screen Objects]

As described above, the commands or messages are displayed on the screen 137 in order to establish proper guidance for or indication to the operator. In addition, the screen 137 is made to indicate an ultimate pattern, contents of all processes for forming the ultimate pattern, and details of a currently performed process.

For example, an assumption is made that the embroidering and dyeing system EBS is operated to produce a pattern as shown in FIG. 13 on the cloth W. The pattern includes a bold annular ring configuration, a character “A” configuration, and a black star configuration. The bold annular ring configuration is produced by embroidering and later gold color dyeing. The character “A” configuration is produced by only embroidering and the black star configuration is produced by dyeing only. If the embroidering machine 200 is brought into operation prior to the operation of the dyeing machine 300, the production of the FIG. 13 shown pattern takes the following four processes.

PROCESS-1: Formation of the annular ring configuration by embroidering

PROCESS-2: Formation of the character “A” configuration by embroidering

PROCESS-3: Dyeing the embroidered annular configuration

PROCESS-4: Formation of the black star configuration

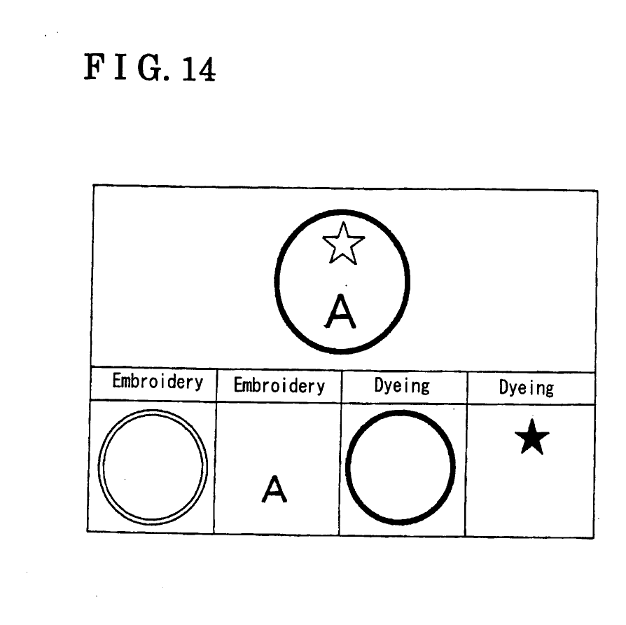

The control program stored in the control device 100 for controlling the embroidering and dyeing system EBS, during its operation, displays an indication shown in FIG. 14 on the screen 137, which provides sufficient pieces of information to the operator for the effective operations of the embroidering and dyeing. In detail, as shown in FIG. 14, an ultimate or objective pattern is shown at the upper portion, boxed operation type is shown at the middle portion, and the unit configurations of the ultimate pattern each of which is formed by the middle-portion-shown operation. During the operation of the embroidering and dyeing system EBS one of the boxes at the middle portion lights.

With the construction of the embodiment of the present invention, the embroidering and dyeing system includes the control device, the embroidering machine controlled by the control device, and a dyeing device controlled by the control device configured to operate independently from the embroidering machine. Because the objective pattern formed by the embroidering machine and/or the dyeing device is displayed on the screen along with the forming process, the progress for forming the pattern can be easily recognized by the operator.

A second embodiment of the present invention will be explained as follows. The construction and the operation of the embroidering and dyeing system according to the second embodiment of the present invention are likewise the construction and the operation of the first embodiment.

The integral operation of the embroidering and dyeing system EBS according to the second embodiment of the present invention will be explained as follows. When a starting switch is ON, the control device 100 assumes the operation state. Simultaneously, an initial picture appears at the screen 137 of the display 134 so that the plural patterns are arranged to be displayed. The patterns mainly include, for example, the following categories.
(A) The pattern obtained by dyeing with the dyeing device 300 after embroidering on the cloth W by the embroidering machine 200;
(B) The pattern obtained by embroidering by the embroidering machine 200 after dyeing the cloth W by the dyeing device 300;
(C) The pattern obtained by embroidering on the cloth W by the embroidering machine 200; and
(D) The pattern obtained by dyeing the cloth W by the dyeing device 300.

By clicking the desired pattern with the mouse 133, the second picture including the selected pattern and the command in accordance with the selected pattern appears on the screen in accordance with the selected pattern. The operation of the embroidering and dyeing system will be explained depending on the selected patterns.

When the pattern (A), the pattern obtained by dyeing with the dyeing device 300 after embroidering on the cloth W by the embroidering machine 200 is selected, the screen 137 displays the image of the pattern with color. For example, the pattern as shown in FIG. 13 may be produced on the cloth by the embroidering and dyeing system. The pattern includes a circle configuration, an A configuration, and a black star configuration. The circle configuration is produced by dyeing with gold color after embroidering. The A configuration is produced by embroidering and the back star configuration is produced by dyeing. For example, in case the embroidering machine 200 is operated before the operation of the dyeing machine 300, the pattern shown in FIG. 13 is produced with the following four steps.

First, embroidering produces the circle configuration.

Second, embroidering produced the A configuration.

Third, the circle configuration produced by the embroidering is dyed.

And, fourth, the black star configuration is dyed.

The control program included in the control device 100 for controlling the embroidering and dyeing system displays the information shown in FIG. 14 on the screen 137 during the operation of the embroidering and dyeing system 100, which provides the sufficient information to the operator for the efficient operation of the embroidering and dyeing. For example, as shown in FIG. 14, the objective pattern is shown at the top portion, the variations of the operation is displayed at the middle portion, and the unit pattern formed by the variation of the operation shown at the middle portion is displayed.

The pattern (i.e., the objective pattern shown in FIG. 13 and the unit pattern for constructing the objective pattern; the pattern produced by the first to fourth steps) displayed on the screen 137 is shown with colored line drawings. In other words, the objective pattern shown in FIG. 13 is displayed with colored line drawings at a top portion of the screen 137 and the unit patterns, i.e., the pattern produced in the first to fourth steps are independently displayed to be arranged in line with colored line drawings at a bottom portion of the screen 137. By the operation of the operator for changing the configuration of the pattern produced at the first step displayed at the bottom left of the screen 137 with a click of a mouse, or the like, the configuration of the corresponding portion of the objective pattern at the screen 137 is changed simultaneously cooperating the change of the unit pattern. Likewise, by changing the configuration of the patterns produced at the second through fourth steps with a click of the mouse, or the like, the configuration of the corresponding portions of the objective pattern at the screen 137 are changed simultaneously cooperating the change of the unit patterns. Further, in case of replacing the thread with a color by the thread with another color, the operator selects the favorable color from a table of the color data displayed on the screen 137 when clicking the line drawings. Accordingly, the contents of the predetermined thread color Ci of the management data is amended and the needle number Ni is added in order to correspond to the selected color. In case the selected color is not supplied at none of the needles, the dyeing data is automatically amended assuming that the patterns embroidered with the thread is to be dyed. Likewise, the color used for the dyeing can be changed by clicking the line drawings.

Thereafter, the command saying “input the frame number, and set the frame set with the cloth at the embroidering machine” or the like is displayed on the screen. Following the command, by setting the frame device FR set with the cloth W to the embroidering machine 200 after inputting the number showing the size of the frame device FR set with the cloth W to operate the embroidering machine 200, the frame device FR moves to the embroidering start point according to the size thereof to apply the predetermined embroider on the cloth W. During the embroidering operation, the time T until completing the operation is displayed at the screen 137. When the embroidering operation is completed, the buzzer sounds and the commands saying “set the cloth at the dyeing device without removing from the frame”, or the like, is displayed. Following the command by setting the frame device FR set with the cloth W at the dyeing device 300 to operate the dyeing device 300, the frame device moves to the dyeing starting point according to the size thereof (i.e., the size is acknowledged by the control device 100 when inputted at the screen 137), the specified portion of the embroidered cloth W is dyed. When the ink is completely dried by the completion of the dyeing operation, the buzzer sounds and the command saying “remove the frame”, or the like is displayed. Accordingly, the cloth W dyed after the embroidering can be obtained. As shown in FIG. 14, for example, four windows are provided at a middle portion of the screen 137 and the operator can recognize the currently operating device and the patterns produced by the currently operating device by observing the blinking window. By switching the usage mode of the dyeing device 300 during the embroidering operation, another cloth can be dyed independently.

In case the pattern (B), the pattern obtained by embroidering by the embroidering machine 200 after dyeing the cloth W by the dyeing device 300, is selected, the image of the pattern is displayed on the screen 137. The patterns on the screen, the thread color, and the color for the dyeing can be changed likewise the case for the pattern (A).

Thereafter, the command saying “input the frame number, and set the frame set with the cloth to the dyeing device” or the like, is displayed on the screen 137. By setting the frame device FR set with the cloth W to the dyeing device 300 and operating the dyeing device 300 after inputting the number indicating the size of the frame device FR set with the cloth W at the screen 137, the frame device FR is moved to an initial position for the dyeing in accordance with the size of the frame device FR so that the predetermined dye is provided at the cloth W. When the dyeing operation is completed and the ink is completely dried, the buzzer sounds and the command saying “set the frame to the embroidering device without removing the cloth from the frame” or the like, is displayed. By setting the frame device FR set with the dyed cloth W to the embroidering machine 200 and operating the embroidering machine 200, the frame device FR is moved to the initial position for the embroidering in accordance with the size of the frame device FR (i.e., the size of the frame device FR is acknowledged by the control device 100 when inputted at the screen 137) so that the predetermined embroider is provided on the cloth W. During the embroidering operation, the time until the completion of the operation is displayed on the screen 137. When the embroidering operation is completed, the buzzer sounds and the command saying “remove the frame” or the like is displayed. Thus, the cloth W provided with the embroider after dyeing can be obtained. By switching the usage mode of the dyeing device 300 during the embroidering operation, another cloth can be dyed independently from the embroidering operation.

In case the pattern (C), the pattern obtained by embroidering on the cloth W by the embroidering machine 200, is selected, the pattern is displayed with the color. The pattern, and the thread color are changeable likewise the case of the pattern (A). The selected pattern and the command saying “input the frame number, and set the frame set with the cloth W to the embroidering machine” or the like are displayed. By setting the frame device FR set with the cloth W to the embroidering machine 200 and operating the embroidering machine 200 after inputting the number showing the size of the frame device FR set with the cloth W at the screen 137 following the direction, the frame device FR is moved to the initial position for the embroidering in accordance with the size of the frame device FR so that the predetermined embroider is provided on the cloth W. During the embroidering operation, the time until the completion of the operation is displayed at the screen 137. When the embroidering operation completes, the buzzer sounds and the command saying “remove the frame” or the like is displayed. Thus, the cloth W provided with the embroidery can be obtained. By switching the usage mode of the dyeing device 300 during the embroidering operation, another cloth can be dyed independently from the embroidering operation.

In case the pattern (D), the pattern obtained by dyeing the cloth W by the dyeing device 300, is selected, the pattern is displayed with the color. The pattern and the thread color are changeable likewise the case of the pattern (A). The selected pattern and the command saying “input the frame number, and set the frame set with the cloth to the dyeing device” is displayed on the screen 137. By setting the frame device FR set with the cloth W to the dyeing device 300 and operating the dyeing device 300 after inputting the number for indicating the size of the frame device FR set with the cloth W at the screen 137, the predetermined dye is provided on the cloth W. When the dyeing operation is completed and the ink is completely dried, the buzzer sounds and the command saying “remove the frame” can be displayed. Thus, the cloth W provided with the dyeing can be obtained. The same pattern can be obtained even if the dyeing device 300 is operated independently from the embroidering machine 200.

With the construction of the second embodiment of the present invention, the embroidering and the dyeing system includes the embroidering machine for producing the embroidering pattern depending on the embroidering data and the dyeing device for producing the dyeing pattern depending on the dyeing data, for forming the objective pattern on the work with the embroidering pattern and the dyeing pattern. Because the embroidering pattern and/or the dyeing pattern are displayed individually on the screen and the color and the configuration of the pattern can be changed at the screen, the objective pattern can be easily and appropriately changed.

The principles, preferred embodiment and mode of operation of the present invention-have been described in the foregoing specification. However, the invention which is intended to be protected is not to be construed as limited to the particular embodiments disclosed. Further, the embodiments described herein are to be regarded as illustrative rather than restrictive. Variations and changes may be made by others, and equivalents employed, without departing from the sprit of the present invention. Accordingly, it is expressly intended that all such variations, changes and equivalents which fall within the spirit and scope of the present invention as defined in the claims, be embraced thereby.

1. An embroidering and dyeing system comprising:
a controller;
an embroidering machine controlled by the controller; and
a dyeing device controlled by the controller, the dyeing device being operable independently from the embroidering machine; wherein
an objective pattern formed by the embroidering machine and/or the dyeing device and processes for forming the objective pattern are displayed on a screen.

2. The embroidering and dyeing system according to claim 1, wherein the objective pattern and the processes for forming the objective pattern are displayed on the screen individually or collectively.

3. The embroidering and dyeing system according to claim 1, wherein the objective pattern is capable of being changed in color and/or configuration.

4. The embroidering and dyeing system according to claim 3, wherein the change of the objective pattern is made via the screen.

5. The embroidering and dyeing system according to claim 1, wherein the objective pattern is displayed together with its component configurations.

6. The embroidering and dyeing system according to claim 5, wherein the objective pattern and the component configurations appear on upper and lower sides, respectively, in the screen.

7. The embroidering and dyeing system according to claim 6, wherein the component configurations displayed on the screen are arranged in process sequence.

8. The embroidering and dyeing system according to claim 7, wherein each of the component configurations, during formation thereof, is lit for clarification.

9. The embroidering and dyeing system according to claim 7, wherein an on-screen indication appears near each of the component configurations in order to indicate whether the formation thereof is to be embroidering or by dyeing.

10. The embroidering and dyeing system according to claim 9, wherein the on-screen indication and the corresponding component configuration are arranged in column.

11. The embroidering and dyeing system according to claim 10, wherein the on-screen indication is placed just above the corresponding component configuration.

12. The embroidering and dyeing system according to claim 9, wherein during formation of each of the component configurations, at least one of the each of the component configurations and the corresponding on-screen indication is lit for clarification.

13. The embroidering and dyeing system according to claim 1, wherein the embroidery machine and the dyeing device embroideries and dyes, respectively, a work piece which is held on a common frame device.

14. The embroidering and dyeing system according to claim 13, wherein whenever the embroidery machine and the dyeing device terminate respective operations, a command appears as to a next procedure.

15. The embroidering and dyeing system according to claim 13, wherein whenever the embroidery machine and the dyeing device terminate respective operations a buzzer sounds.

16. The embroidering and dyeing system according to claim 13, wherein whenever the embroidery machine and the dyeing device terminate respective operations a command appears as to a next procedure and a buzzer sounds.
